(19) United States
(12) Patent Application Publication
(10) Pub. No.: US 2025/0242362 A1
(43) Pub. Date: Jul. 31, 2025

(54) PM Transition

(71) Applicants: James Van Houten, Bulverde, TX (US); Steven Mautz, Bulverde, TX (US)

(72) Inventors: James Van Houten, Bulverde, TX (US); Steven Mautz, Bulverde, TX (US)

(21) Appl. No.: 18/428,841

(22) Filed: Jan. 31, 2024

(51) Int. Cl. B05B 9/01; B05B 12/00; B05B 12/08

(52) U.S. Cl. CPC B05B 9/01; B05B 12/0026; B05B 12/087

(57) ABSTRACT

A spray gun includes a housing having a first axial end and a second axial end arranged opposite to the first axial end. The housing defines a chamber extending from the first axial end to the second axial end. The spray gun also includes a U-shaped handle connected to the housing and having a column extending obliquely and forwardly from the housing to enable a user to hold the spray in an inverted position. The spray gun also includes a spray assembly arranged inside the housing and including an inlet conduit extending partially inside the chamber. The inlet conduit extends obliquely and downwardly inside the chamber from the first axial end. The spray assembly also includes a lever arranged forwardly of the column and adapted to be pressed to enable a discharge of the fluid from the spray gun.

### TECHNICAL FIELD

The present disclosure relates, generally, to a spray gun, and more particularly to a power washer spray gun having a lever that enables a holding of the spray gun in an inverted position, providing a better control to a user during dispensing of the liquid.

### BACKGROUND

Power washers spray guns are used to clean any surface such as walls, driveways, decks that have caked-on dirt, grease, dust or any other contaminants using high pressure liquid, typically water. A user may suffer from muscle stress or strain as constant back pressure is produced against the hand and the wrist of the user because of the high-pressure liquid expulsion from the spray gun. Therefore, the user may not have the strength to maintain the necessary control of the spray gun, that may cause a misdirected high-pressure stream of water from the gun.

### SUMMARY

One aspect of this disclosure relates to a spray gun for ejecting fluid. The spray gun includes a housing having a first axial end and a second axial end arranged opposite to the first axial end. The housing defines a chamber extending from the first axial end to the second axial end. The spray gun also includes a U-shaped handle connected to the housing and having a column extending obliquely and forwardly from the housing to enable a user to hold the spray in an inverted position. The spray gun also includes a spray assembly arranged inside the housing and including an inlet conduit extending partially inside the chamber. The inlet conduit extends obliquely and downwardly inside the chamber from the first axial end. The spray assembly also includes a lever arranged forwardly of the column and adapted to be pressed to enable a discharge of the fluid from the spray gun.

In some additional, alternative, or selectively cumulative embodiments, the spray assembly includes an outlet conduit extending partially inside the chamber and arranged in fluid communication with the inlet conduit to receive the fluid from the inlet conduit. The outlet conduit facilitates a discharge of the fluid.

In some additional, alternative, or selectively cumulative embodiments, the spray assembly includes a valve arranged inside the housing between the inlet conduit and the outlet conduit to control the flow of the fluid from the inlet conduit to the outlet conduit.

In some additional, alternative, or selectively cumulative embodiments, the valve is adapted to be displaced between an open position and a closed position. In the closed position, the valve prevents the flow of the fluid from the inlet conduit to the outlet conduit. In the open position, the valve allows the flow of the fluid from the inlet conduit to the outlet conduit.

In some additional, alternative, or selectively cumulative embodiments, the valve is biased to the closed position and is moved to the open position in response to the pressing of the lever by the user.

In some additional, alternative, or selectively cumulative embodiments, the lever is arranged to pivot between a first position and a second position and is biased to the first position and moves to the second position upon pressing the lever.

In some additional, alternative, or selectively cumulative embodiments, the valve includes a pin configured to be pressed to move the valve to the open position from the closed position.

In some additional, alternative, or selectively cumulative embodiments, the pin is pressed in response to the pivoting of the lever to the second position.

One aspect of this disclosure relates to a spray gun for ejecting fluid. The spray gun includes a housing having a first axial end and a second axial end arranged opposite to the first axial end, and a U-shaped handle connected to the housing and having a column extending obliquely and forwardly from the housing to enable a user to hold the spray in an inverted position. The spray gun also includes a spray assembly having an inlet conduit extending partially inside the housing. The inlet conduit extends obliquely and downwardly inside the housing from the first axial end. The spray assembly also includes an outlet conduit arranged in fluid communication with the inlet conduit to discharge the fluid received from the inlet conduit, and a valve arranged inside the housing between the inlet conduit and the outlet conduit to control the flow of the fluid from the inlet conduit to the outlet conduit. The spray assembly further includes a lever arranged forwardly of the column and adapted to be pressed to move the valve to an open position to allow the flow of the fluid from the inlet conduit to the outlet conduit.

In some additional, alternative, or selectively cumulative embodiments, the valve is adapted to be displaced between the open position and a closed position. In the closed position, the valve prevents the flow of the fluid from the inlet conduit to the outlet conduit.

In some additional, alternative, or selectively cumulative embodiments, the valve is biased to the closed position and is moved to the open position in response to the pressing of the lever by the user.

In some additional, alternative, or selectively cumulative embodiments, the lever is arranged to pivot between a first position and a second position and is biased to the first position and moves to the second position upon pressing the lever.

In some additional, alternative, or selectively cumulative embodiments, the valve includes a pin configured to be pressed to move the valve to the open position from the closed position.

In some additional, alternative, or selectively cumulative embodiments, the pin is pressed in response to the pivoting of the lever to the second position.

### BRIEF DESCRIPTION OF THE ACCOMPANYING DRAWINGS

Having thus described example embodiments of the present disclosure in general terms, reference will now be made to the accompanying drawings, which are not necessarily drawn to scale, and wherein:

FIG. 1 is a perspective view of a spray gun, in accordance with an embodiment of the disclosure;

FIG. 2 is a perspective view of the spray gun of FIG. 1 arranged in an inverted position and a lever removed, in accordance with an embodiment of the disclosure;

FIG. 3 is a perspective view of the spray gun of FIG. 2 showing internal components of the spray gun, in accordance with an embodiment of the disclosure;

FIG. 4 is a perspective view of a spray assembly of the spray gun of FIG. 2, in accordance with an embodiment of the disclosure; and

FIG. 5 is a perspective view of the spray gun of FIG. 1 held by a user in the inverted position, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatus and methods are shown in block diagram form only in order to avoid obscuring the present disclosure.

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc., mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. The use of any term should not be taken to limit the spirit and scope of embodiments of the present disclosure.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

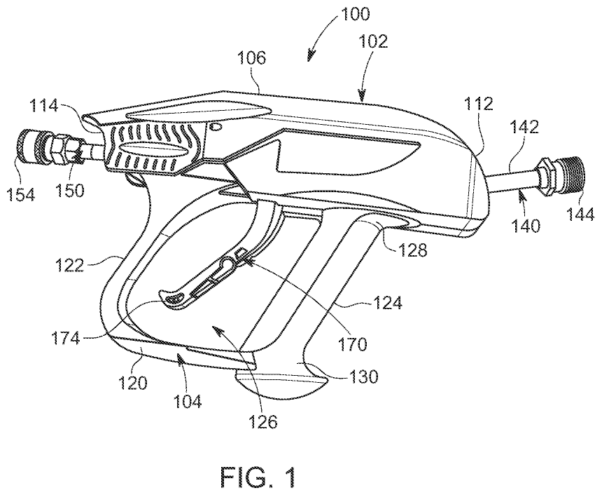

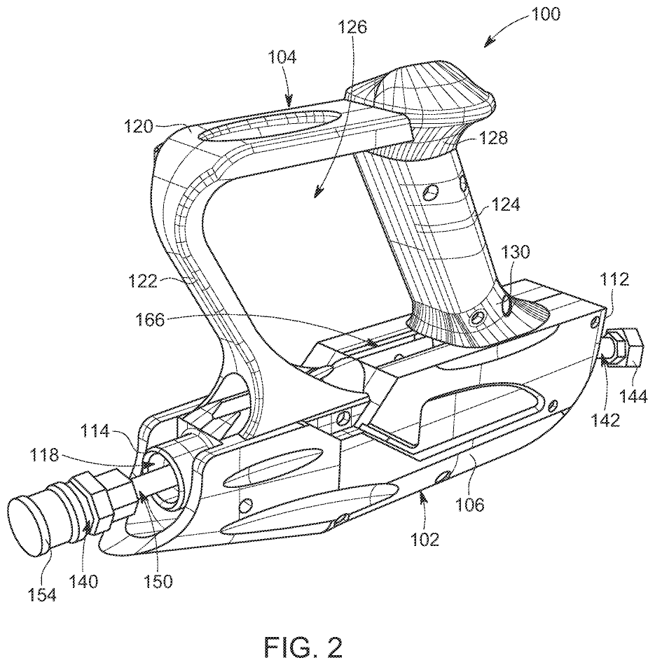

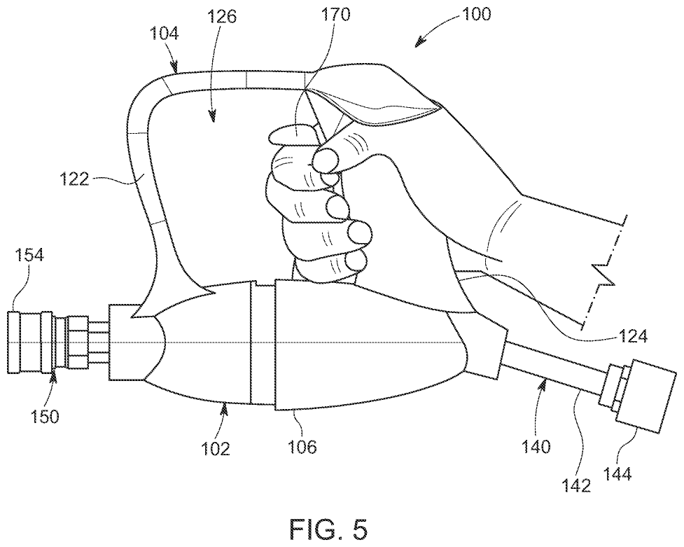

Referring to FIGS. 1 to 3 and 5, a power washer spray gun 100 (hereinafter referred to as gun 100) to control an ejection/outlet of a fluid to clean large surfaces and effectively remove dirt and dust from the surface is disclosed. The spray gun 100 includes a housing 102 to house a plurality of components of the gun 100 and a handle 104 attached to the housing 102 to enable a user to hold the gun 100. The housing 102 and the handle 104 are arranged such that the handle 104 is arranged above the housing 102 during the spray of the fluid from the gun 100. Accordingly, the gun 100 is held in an inverted position (shown in FIG. 5) for spraying of the fluid from the gun 100.

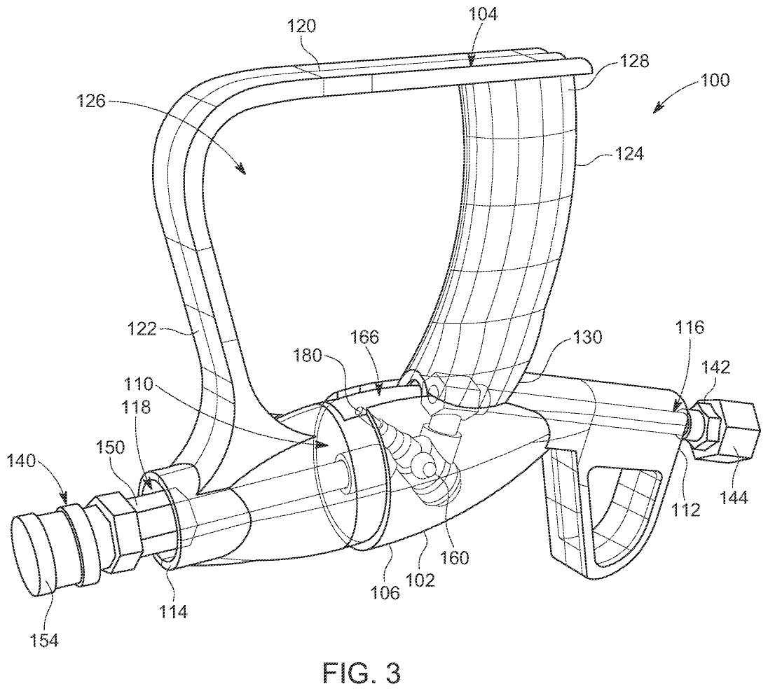

As shown, the housing 102 includes a substantially cylindrical wall 106 having an inner surface defining a chamber 110 (shown in FIG. 3) to house the plurality of components of the gun 100. The housing 102 includes a first axial end 112 and a second axial end 114 arranged opposite to the first axial end 112. As illustrated, the chamber 110 extends from the first axial end 112 to the second axial end 112 with a first opening 116 of the chamber 110 arranged at the first axial end 112 and a second opening 118 of the chamber 118 disposed at the second axial end 114.

Further, the handle 104 is arranged between the first axial end 112 and the second axial end 114 and includes a substantially U shape having a base wall 120 arranged at a distance from the housing 102 and extending in a direction of extension of the housing 102, a first column 122 extending from the base wall 120 to the housing 102 and a second column 124 arranged spaced apart from the first column 122 defining a space 126 therebetween. The second column 124 also extends from the base wall 120 to the housing 102 and is connected to the housing 102. As shown, the second column 124 is arranged proximate to the first axial end 112 of the housing 102 relative to the first column 122. Also, in some embodiments, the second column 124 may extend obliquely and rearwardly from the housing 102 such that a bottom end 128 of the second column 124 is disposed distally, in a longitudinal direction, to the first axial end 112 of the housing 102 relative to an upper end 130 of the second column 124. The inclination of the second column 124 in the rearward direction facilitates an easy holding of the gun 100 in the inverted position.

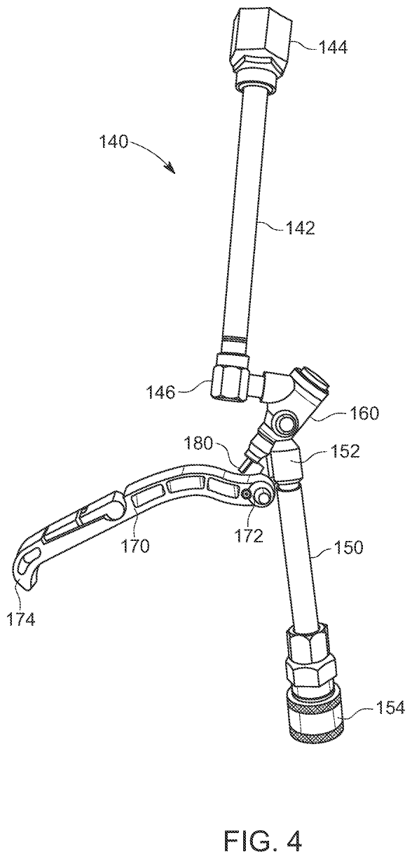

Further, referring to FIG. 4, the gun 100 includes a spray assembly 140 configured to receive fluid from a source, for example, a reservoir, a pump, etc., and eject the fluid on the surface to be cleaned. As shown, the spray assembly 140 includes an inlet conduit 142 extending, at least partially, inside the chamber 110, and having a first end 144 that may be arranged outside the housing 102, as shown in FIGS. 1 to 3, and 5, and outwardly of the first axial end 112 of the housing. Accordingly, the inlet conduit 142 extends inside the chamber 110 through the first opening 116 with an inlet port of the inlet conduit 142 arranged rearwardly of the first opening 114 and an outlet port of the inlet conduit 142 arranged inside the chamber 110. The inlet conduit 142 may include suitable structural features at the first end 144 to enable a coupling/connection/engagement of the inlet conduit 142 with a suitable hose that facilitates a delivery of the fluid from the fluid source to the inlet conduit 142 and hence the gun 100. Moreover, as illustrated in FIG. 3, the inlet conduit 142 extends obliquely downwardly in the longitudinal direction and inside the chamber 110 from the first opening 116. Accordingly, the inlet conduit 142 extends obliquely upwardly, inside the chamber 110, from the first opening 116 when the gun 100 is arranged in the inverted position.

Further, the spray assembly 140 includes an outlet conduit 150 fluidly coupled to the inlet conduit 142 and configured to discharge the fluid received from the inlet conduit 142. As with the inlet conduit 142, the outlet conduit 150 is at least partially arranged inside the housing 102 (shown in FIG. 3) and includes an inlet end 152 arranged inside the housing 102 and an outlet end 154 arranged forwardly of the second opening 118 of the chamber 110. Accordingly, a portion of the outlet conduit 150 extends outside the housing 102 through the second opening 118. The inlet end 152 defines an inlet opening of the outlet conduit 150, while the outlet end 154 defines an outlet opening of the outlet conduit 150 through which the fluid is discharged from the gun 100.

To control the flow of the fluid to the outlet conduit 150 and discharge of the fluid from the gun 100, the spray assembly 140 includes a valve 160 arranged inside the housing 102 and between the inlet conduit 142 and the outlet conduit 150 and connected to the inlet and outlet conduits 142, 150. As shown, a second end 146 of the inlet conduit 142 is connected to the valve 160, while the inlet end 152 of the outlet conduit 150 is connected to the valve 160. The valve 160 is adapted to be displaced or operated between an open position and a closed position, and is biased to the close position. In the closed position, the valve 160 prevents the flow of fluid from the inlet conduit 142 to the outlet conduit 150, while the valve 160 allows flow of the fluid from the inlet conduit 142 to the outlet conduit 150 when arranged in the open position. In some embodiments, the valve 160 may include a biasing member to bias the valve to the closed position. Accordingly, the valve 160 is moved to the open position by applying a force against a biasing force of the biasing member.

Therefore, to apply the force, and displace the valve 160 from the closed position to the open position, the spray assembly 140 includes a lever 170 adapted to be operated by the user and having a first end 172 pivotally coupled to the valve 160 (as shown in FIG. 4). Also, the lever 160 extends inside the space 126 defined between two columns 122, 124 of the handle 104 through a cut-out 166 of the housing 102 (best shown in FIG. 3). The lever 170 is configured to pivot between a first position and a second position. In the first position, the lever 170 is arranged away from a pin 180 (shown in FIGS. 3 and 4) of the valve 160, while the lever 170 presses the pin 180 as the lever 170 is moved to the second position, and thereby moves the valve 160 to the open position. It may be appreciated that the lever 170 is biased to the first position and is adapted to be moved/displaced to the second position by the user. Also, a second end 174 of the lever 170 moves rearwardly as the lever 170 is displaced to the second position by the user. As the gun 100 is designed to be held in the inverted position, as shown in FIG. 5, the wrist provides added support to hold the gun 100 and thereby the spray gun 100 is controlled efficiently during cleaning of surfaces.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A spray gun for ejecting fluid, the spray gun comprising:
a housing having a first axial end and a second axial end arranged opposite to the first axial end, the housing defines a chamber extending from the first axial end to the second axial end;
a U-shaped handle connected to the housing and having a column extending obliquely and forwardly from the housing to enable a user to hold the spray in an inverted position; and
a spray assembly arranged inside the housing and including
an inlet conduit extending partially inside the chamber, wherein the inlet conduit extends obliquely and downwardly inside the chamber from the first axial end, and
a lever arranged forwardly of the column and adapted to be pressed to enable a discharge of the fluid from the spray gun.

2. The spray gun of claim 1, wherein the spray assembly includes an outlet conduit extending partially inside the chamber and arranged in fluid communication with the inlet conduit to receive the fluid from the inlet conduit, wherein the outlet conduit facilitates a discharge of the fluid.

3. The spray gun of claim 2, wherein the spray assembly includes a valve arranged inside the housing between the inlet conduit and the outlet conduit to control the flow of the fluid from the inlet conduit to the outlet conduit.

4. The spray gun of claim 3, wherein the valve is adapted to be displaced between an open position and a closed position, wherein
in the closed position, the valve prevents the flow of the fluid from the inlet conduit to the outlet conduit, and
in the open position, the valve allows the flow of the fluid from the inlet conduit to the outlet conduit.

5. The spray gun of claim 4, wherein the valve is biased to the closed position and is moved to the open position in response to the pressing of the lever by the user.

6. The spray gun of claim 5, wherein the lever is arranged to pivot between a first position and a second position and is biased to the first position and moves to the second position upon pressing the lever.

7. The spray gun of claim 6, wherein the valve includes a pin configured to be pressed to move the valve to the open position from the closed position.

8. The spray gun of claim 7, wherein the pin is pressed in response to the pivoting of the lever to the second position.

9. A spray gun for ejecting fluid, the spray gun comprising:
a housing having a first axial end and a second axial end arranged opposite to the first axial end;
a U-shaped handle connected to the housing and having a column extending obliquely and forwardly from the housing to enable a user to hold the spray in an inverted position; and
a spray assembly including
an inlet conduit extending partially inside the housing, wherein the inlet conduit extends obliquely and downwardly inside the housing from the first axial end,
an outlet conduit arranged in fluid communication with the inlet conduit to discharge the fluid received from the inlet conduit,
a valve arranged inside the housing between the inlet conduit and the outlet conduit to control the flow of the fluid from the inlet conduit to the outlet conduit, and
a lever arranged forwardly of the column and adapted to be pressed to move the valve to an open position to allow the flow of the fluid from the inlet conduit to the outlet conduit.

10. The spray gun of claim 9, wherein the valve is adapted to be displaced between the open position and a closed position, wherein in the closed position, the valve prevents the flow of the fluid from the inlet conduit to the outlet conduit.

11. The spray gun of claim 10, wherein the valve is biased to the closed position and is moved to the open position in response to the pressing of the lever by the user.

12. The spray gun of claim 10, wherein the lever is arranged to pivot between a first position and a second position and is biased to the first position and moves to the second position upon pressing the lever.

13. The spray gun of claim 12, wherein the valve includes a pin configured to be pressed to move the valve to the open position from the closed position.

14. The spray gun of claim 13, wherein the pin is pressed in response to the pivoting of the lever to the second position.
